(19) United States
(12) Patent Application Publication
(10) Pub. No.: US 2013/0022701 A1
(43) Pub. Date: Jan. 24, 2013

(54) Mold for a Substantially Frozen Edible Product

(71) Applicants: Neal E. White, Old Tappan, NJ (US); Jack Szymanski, Toms River, NJ (US); Richard Thomas, Bordentown, NJ (US)

(72) Inventors: Neal E. White, Old Tappan, NJ (US); Jack Szymanski, Toms River, NJ (US); Richard Thomas, Bordentown, NJ (US)

(21) Appl. No.: 13/185,899

(22) Filed: Jul. 19, 2011

(51) Int. Cl. B28B 5/02

(52) U.S. Cl. 425/337

(57) ABSTRACT

A molding apparatus for forming a substantially frozen edible product, comprising a mold strip comprising a substantially planar flight having a front edge, a rear edge, and right and left side edges, and a plurality of mold cups fixedly secured along at least a portion of the first planar flight, wherein the front and rear edges each comprise a lip, the lip having a chevron shape.

### BACKGROUND OF THE INVENTION

There is a strong desire in the food industry to form molded frozen food products. The manufacture of frozen edible products, such as sherbets, frozen yogurts, ice water, pureed fruits, ice cream and other frozen dairy products, typically involves, as a first step, the preparation of a mix of ingredients. Commonly, once the desired ingredients are mixed, and typically are also partially frozen, the mix then proceeds to a further manufacturing step, such as mold filling, packaging filling or extrusion. In the step of mold filling, the mix is added to a mold cavity and exposed to a lower temperature such that the mix substantially freezes, to take on the shape of the mold. The substantially frozen mix is then removed from the mold, while maintaining the shape of the mold, and moved to a further manufacturing step such as packaging for distribution to customers.

One process for lowering the temperature of the mold is to use a bath, such as a freezing solution, for example, a calcium chloride aqueous solution or brine solution, within which the mold is placed. Since the mold is typically secured to a conveyor, the mold, positioned along a flight (for example, see FIG. 3) to form a mold strip, moves through the bath during which time the product within the mold substantially freezes. The mold strip was fitted with a lip, as in FIG. 1, which provided structural strength for the mold strip as it moved through the bath. In FIG. 1, molds 80 on the mold strip would include lips 81, 82, 83, 84 along either side edge. These lips would minimize deflection of the mold strip caused by the force of the freezing solution against the moving molds.

Recently, manufacturing systems for frozen edible products have used spray systems in place of the baths. The spray system sprays a freezing solution onto the molds to decrease the temperature of the mold, and thus, substantially freezing the edible product. The solution is then reclaimed by a residual collection area, which then recycles the solution back to the spray system. This spray system provides for a faster freezing of the product than a traditional bath system. One such system is the Cascade Freezing System (WCB Ice Cream, Northvale, N.J.), covered by U.S. Pat. No. 5,359,858, incorporated by reference herein as if fully set forth herein.

However, using a freezing solution has the drawback of significantly increasing the risk of passage of the solution over the top of the mold and into the cavity, and thus infiltrating the edible product. Such infiltration is also possible in traditional bath systems. If a brine solution is used such as, for example, a calcium chloride aqueous solution, such infiltration could have a negative impact on the taste of the finished edible product.

To prevent such infiltration of the molds in either spray or bath systems, and to maintain the structural support of the mold strips, the mold strips were fitted with a lip such as is illustrated in FIG. 2. One lip 92, 94 of molds 90, 90A is L-shaped which nests with the other lip 91, 93 of an adjacent mold, to prevent passage of the solution from the bottom of the molds up and into the cavity 95 of the molds. Such lip is also found in U.S. Pat. No. 4,576,562, owned by a predecessor company of the present assignee, WCB Ice Cream, which is incorporated by reference herein as if fully set forth herein. However, the L-shape of the lip also allowed the freezing solution to become trapped in between the two lips 92, 93, and unable to be reaclaimed, which resulted in loss of the freezing solution.

### BRIEF SUMMARY OF THE INVENTION

Therefore, a new shape of lip should be used to minimize loss of solution, and to provide for a manufacturing system having a lower cost of operation and greater efficiency. In one embodiment, the lip may have a chevron shape, such that two molds adjacent one another may have substantially similar chevron lips adjacent one another which may prevent the freezing solution from contacting or infiltrating the edible product within the mold cavity.

In another embodiment, the present invention may include a molding apparatus for forming a substantially frozen edible product, which includes a mold strip comprising a substantially planar flight having a front edge, a rear edge, and right and left side edges, and a plurality of mold cups fixedly secured along the first planar flight, wherein the front and rear edges each comprise a lip, the lip having a chevron shape. Further, one of the right or left side edges may include an engaging structure comprising one of a slot or a fixation button. The engaging structure may be adapted to releasably engage a conveyor, the conveyor having the other of the slot or the fixation button. The fixation button may be a bolt, a movable pin, a screw, a tack, or the like. Additionally, the other of the right or left side edges may include one of at least one bore hole or at least one securement pin.

In a further embodiment, the present invention may include a molding apparatus for forming a substantially frozen edible product, comprising a first mold strip comprising a first substantially planar flight having a front edge, a rear edge, and right and left side edges, and a first plurality of mold cups fixedly secured along the first planar flight; a second mold strip comprising a second substantially planar flight having a front edge, a rear edge, and right and left side edges, and a second plurality of mold cups fixedly secured along the second planar flight; and the front edge of the first planar flight and the rear edge of the second planar flight arranged adjacent one another, wherein the front edge of the first planar flight and the rear edge of the second planar flight have complementary chevron shapes. Further, the right and left side edges of the first and second molding strips may include an engaging structure comprising one of a slot or a fixation button. Additionally, the engaging structure may be adapted to engage a conveyor, the conveyor having the other of the slot or the fixation button. The fixation button may include, for example, a bolt, a screw or a tack.

The apparatus of this embodiment may further comprise a freezing system adapted to apply a freezing solution on an outer surface of the pluralities of mold cups, wherein the freezing solution may have a temperature capable of freezing the edible product within cavities of the mold cups. Further, the freezing system may be positioned along a portion of a length of the conveyor. The freezing solution may include, for example, a calcium chloride solution or a propylene glycol solution. Moreover, the complementary chevron shapes may be adapted to prevent the freezing solution from entering the cavities of the mold cups. Thus, the chevron shapes may prevent the freezing solution from infiltrating the cavity of the mold and the edible product. The apparatus may further comprise a freezing solution collection area, positioned along a portion of the length of the conveyor downstream of the freezing system, wherein the freezing solution falling from the pluralities of mold cups may be collected. Further, the first and second mold strips are substantially identical. Also, the apparatus may further comprise three of more mold strips, all of which are substantially identical to one another.

In another embodiment, the present invention may include a manufacturing process for forming a substantially frozen edible product, comprising adding an edible product into a plurality of molding cups of a molding apparatus, the apparatus comprising a conveyor adapted to travel along a path from an upstream location to a downstream location; a first mold strip comprising a first substantially planar flight having a front edge, a rear edge, and right and left side edges, and a first plurality of mold cups fixedly secured along the first planar flight; a second mold strip comprising a second substantially planar flight having a front edge, a rear edge, and right and left side edges, and a second plurality of mold cups fixedly secured along the second planar flight; the front and rear edges of the first and second planar bodies having a chevron lip; the first and second mold strips removeably secured to the conveyor such that the rear edge of the first planar flight and the front edge of the second planar flight are adjacent one another to position one of the chevron lips of the first planar flight in a complementary arrangement with one of the chevron lips of the second planar flight; applying a freezing solution, at an upstream location, to an outer surface of the pluralities of mold cups, the freezing solution has a temperature sufficient to substantially freeze the edible product within the mold cups, wherein the complementary chevron lips are adapted to shield the edible product from the freezing solution; and collecting residual freezing solution falling from the first and second mold strips at a downstream location from the step of applying the freezing solution. Additionally, the right and left side edges of the first and second molding strips may include an engaging structure comprising one of a slot or a fixation button, wherein the fixation button may include a bolt, a screw, a tack, or the like. The engaging structure may be adapted to engage a conveyor, the conveyor having the other of the slot or the fixation button.

Further, the freezing solution may be a brine solution, for example, calcium chloride. The freezing solution may also be, for example, propylene glycol. The process may further comprise a continuous process such that the conveyor is a continuous loop which may have a plurality of mold strips sufficient to form a continuous loop of mold strips along the conveyor. In one exemplary process, the step of adding the edible product may be upstream of the step of applying the freezing solution. In an alternate exemplary process, the step of adding the edible product may be downstream of the step of applying the freezing solution, and upstream of the step of collecting residual freezing solution.

### BRIEF DESCRIPTION OF THE DRAWINGS

FIG. 1 illustrates a cross-section of a prior art mold apparatus.

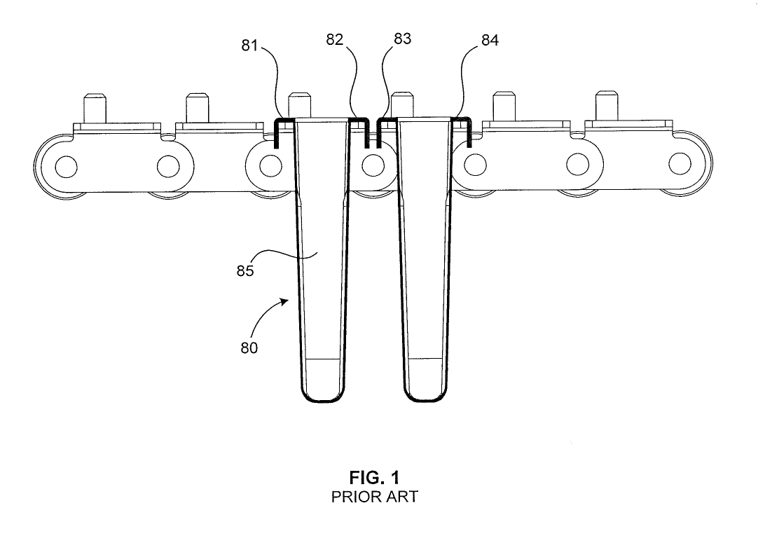

FIG. 2 illustrates another cross-section of a prior art mold apparatus.

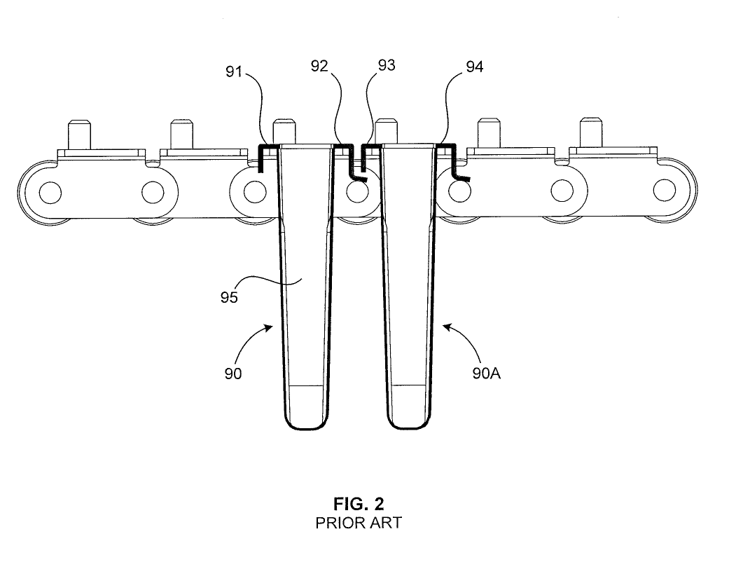

FIG. 3 illustrates one embodiment of the mold strip of the present invention.

FIG. 4 illustrates a cross-section of the mold strip of FIG. 3.

### DETAILED DESCRIPTION

In a first embodiment of the present invention, a first mold strip 10 includes a substantially planar flight 15 having a front edge, a rear edge, and right and left side edges, and a plurality of mold cups 40 having an outer surface 46 and an inner cavity 45. The right and left side edges have structures which releasably engage a conveyor 20. The conveyor may be a belt, chain, or other structure known in the art.

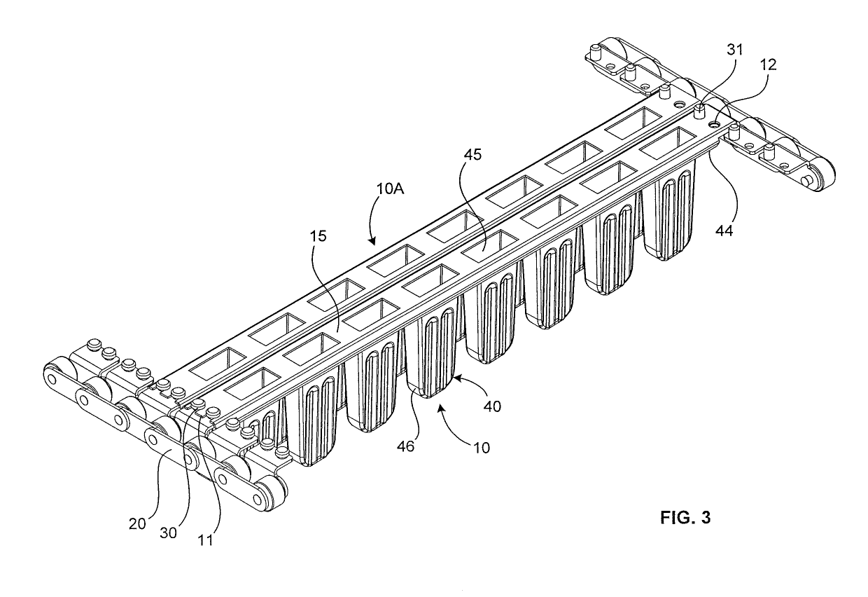

In one example, as illustrated in FIG. 3, one of the right or left side edges of the strip 10 may include a slot 11, within which a fixation button 30, or the like, may be positioned. Of course, this slot and button arrangement may be reversed such that the slot is on the conveyor and the button is on the mold strip. The fixation button may be a bolt, moveable pin, tack, screw, or the like. To further the example, the other side edge of the mold strip may include one of at least one bore hole 12 and at least one securement pin 31. In this embodiment, the pin 31, located on the conveyor, may be positioned within the bore hole 12 to minimize lateral motion of the mold strip 10. The pin 31 may further include a locking feature (not shown) such as a spring-loaded push pin, or the like. These side edge structures allow for releasable engagement with the conveyor such that they may easily be removed by a technician for repair, cleaning, replacement, or the like.

The mold strips 10, 10A, as illustrated in FIG. 3, include seven mold cups 40 on each strip, though this number may vary to any number desired. Moreover, the shape of the mold cups may differ from those illustrated, based on the desire of the user.

Mold cups 40 may be fixedly secured to the flight 15, to form mold strips 10, 10A, by any means, such as by welding or the like. Further, they may be manufactured from the same monolithic material as the mold strips, such that the mold cups 40 are extruded, or otherwise formed by pressing, from the solid, substantially planar flight material. In one example, the mold strip is formed by laser cutting openings along the flight 15 within which the mold cups may be placed. The mold cups may then be welded into place. The front and rear edges of the strip may be bent to form the chevron lip 44 shapes.

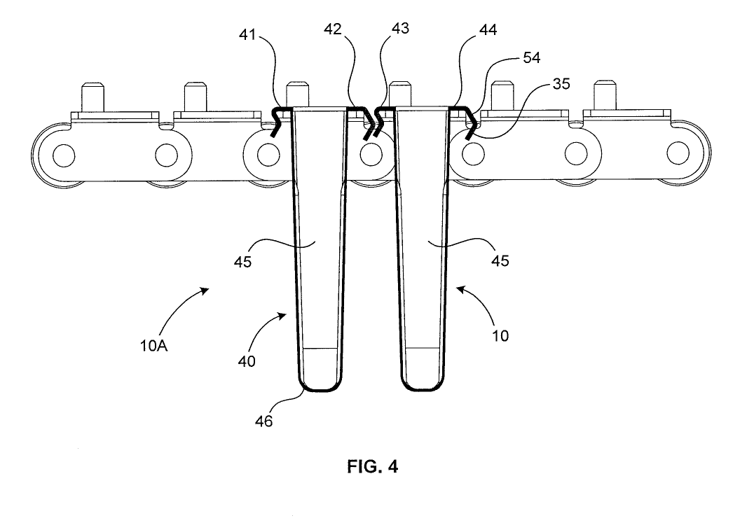

FIG. 4 illustrates a cross-sectional view of mold strips 10, 10A such that a cross-section of a single mold cup 40 from each strip is shown. Once again, the actual shape of the mold cups may differ from those illustrated.

The mold cups 40 of this embodiment include lips 41, 42, 43, 44 on both of the front and rear edges. As in FIG. 3, these lips may extend continuously along the length of the strip 10, though it is envisioned they may alternatively have a limited length only to the width of each individual mold cup, or any length in between. The lips 41, 42, 43, 44 of this embodiment have a chevron shape, in that each lip first extends at an angle 54 diagonal from the mold cup, and then turns to another angle 55 also diagonal to the mold cup but different from the first angle. The specific angle of each section of the chevron shape may be any angle sufficient to prevent the freezing solution, discussed below, from passing over the lips, but still allow the freezing solution to easily and quickly escape from the lips. While the lips, such as lips 42 and 43, are illustrated to be substantially similar or complimentary in shape, they may differ in some respects, so long as the general chevron shapes are maintained. Moreover, the complimentary shaping of adjacent lips may further assist in preventing intrusion into the interior 45 of the mold cups 40 by the freezing solution.

As in FIG. 4, multiple mold strips 10, 10A are positioned adjacent one another such that a lip 42 on the leading edge of one strip 10A is adjacent to a lip 43 on the trailing edge of another strip 10. Of course, while only two strips are illustrated, any number over two may be incorporated onto the conveyor and may be positioned in such an arrangement. The combination of lips 42 and 43 forms a tortuous path through which the freezing solution would be forced to travel, making such passage through the path and into the cavities 45 of the mold cups less likely, if not substantially preventable altogether.

The mold strip 10 of this embodiment, when placed on the conveyor, may be used in a molding apparatus for forming a substantially frozen edible product. This apparatus may include, for example, at least one mold strip 10, releasably engaged to a conveyor. However, in normal manufacturing operation, a plurality of mold strips would be included on the conveyor such that a continuous operation may take place where mold strips are positioned along substantially the entire length of the conveyor. While it is generally envisioned that each mold strip would be substantially identical to the other mold strips on the conveyor, the system could accommodate different mold strips having differing mold cup shapes, differing numbers of mold cups per strip, or the like. The conveyor may then travel in a continuous loop.

Thus, furthering the example of the continuous system, the mold cups 40 of the strip 10 may first be filled with edible product, such as ice cream or the like, at a temperature above the freezing point of the particular product. The conveyor may then bring the particular strip 10 to a spray-freezing system (not shown) which may be adapted to spray a freezing solution on the outer surface 46 of the mold cups 40. In one embodiment, the spray system may spray the freezing solution onto the underside of the lips 41, 42, 43, and allow the solution to then cascade down the outer surface 46 of the mold cups. The freezing solution may have a temperature capable of freezing the edible product within the cavities 45 of the mold cups, the temperature may be, for example, −40 degrees Fahrenheit or Celcius. This spray system may be positioned along a portion of the length of the conveyor, which may depend on the type of edible product in the mold cups and the level of freezing desired. For example, the user may want the edible product to be substantially frozen, and would thus adjust the length of time each mold strip 10 is exposed to the freezing solution by altering, for example, the number of spray jets in the system, the speed of the conveyor, or the like. The freezing solution may be any material, though it should be substantially liquid at the desired temperature. For this example, a calcium chloride or propylene glycol aqueous solution may be used.

It should be noted that the spray system may contact the mold cups prior to the addition of the edible product to pre-freeze the mold cups. Thus, these two steps need not be in any particular order.

A freezing solution collection area may be positioned along a portion of the length of the conveyor. This area may collect the freezing solution falling away from the mold strip 10. This collection area may be positioned downstream of the spray-freezing system, though a portion of the collection area may overlap the spray-freezing system to ensure collection of at least a substantial amount of the freezing solution. Concurrent with or adjacent to at least a portion of the freezing solution collection area, a substantially frozen edible product collection area may remove the edible products from the mold to be sent to further processing areas such as packaging, decoration, or the like.

Continuing this example, the now-empty mold cups continue along the conveyor, which may now loop around substantially 180 degrees, such that the mold cups are upside down, to travel back to the start of the manufacturing process and be refilled with new edible product. During this return travel, the mold cups may be cleaned, the cavities 45 may be prepped with a non-stick substance, the molds may be allowed to thaw, or the like.

Alternative or additional subsystems may be included on this manufacturing apparatus such as a “stick placement” system to position a stick within each of the mold cups filled with edible product. Other known systems may also be included as required.

In another embodiment, the present invention may include a manufacturing method for forming a substantially frozen edible product, which may include adding an edible product into a plurality of molding cups 40 of a mold strip 10 of a molding apparatus, the apparatus comprising a conveyor 20 adapted to travel along a path from an upstream location to a downstream location; a first mold strip 10 comprising a first substantially planar flight 15 having a front edge, a rear edge, and right and left side edges, and a first plurality of mold cups 40 fixedly secured along at least a portion of the first planar flight; a second mold strip 10A comprising a second substantially planar flight having a front edge, a rear edge, and right and left side edges, and a second plurality of mold cups fixedly secured along at least a portion of the second planar flight; the front and rear edges of the first and second planar bodies having a chevron lip 41, 42, 43, 44; the first and second mold strips removeably secured to the conveyor such that the rear edge of the first planar flight and the front edge of the second planar flight are adjacent one another to position one of the chevron lips 43 of the first planar flight in a complementary arrangement with one of the chevron lips 42 of the second planar flight; applying a freezing solution, at an upstream location, to an outer surface 46 of the pluralities of mold cups, the freezing solution has a temperature sufficient to substantially freeze the edible product within the mold cups, wherein the complementary chevron lips are adapted to shield the edible product from the freezing solution; and collecting residual freezing solution falling from the first and second mold strips at a downstream location from the step of applying the freezing solution. Additionally, the right and left side edges of the first and second molding strips may include an engaging structure comprising one of a slot 11 or a fixation button 30, wherein the fixation button may be a bolt, a screw, a movable pin, a tack, or the like. The engaging structure may be adapted to engage a conveyor 20, the conveyor having the other of the slot 11 or the fixation button 30.

This method, as above as to the system, may include other manufacturing steps such as using a freezing solution collection area for collecting the freezing solution applied by the spray-freezing system, or alternatively by a bath, and removing the substantially frozen edible products from the molds using an edible product collection area.

The mold strips, flights, mold cups, lips, and other structures, may be constructed on any material suitable for use under the conditions discussed above, including exposure to freezing temperatures, brine solutions, and the like. The material should also be suitable for use in the production of edible products. For example, 316L stainless steel may be used. The dimensions of the various structures of the present invention should also be suitable to withstand the forces and temperatures encountered in forming an edible product, as described above. The width and depth of the mold cups may be any size suitable to form an edible product, and the length of the flight may be dependent on the number of mold cups desired to be on any single flight.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A molding apparatus for forming a substantially frozen edible product, comprising:
a first mold strip comprising a first substantially planar flight having a front edge, a rear edge, and right and left side edges, and a first plurality of mold cups fixedly secured along the first planar flight;
a second mold strip comprising a second substantially planar flight having a front edge, a rear edge, and right and left side edges, and a second plurality of mold cups fixedly secured along the second planar flight; and
the front edge of the first planar flight and the rear edge of the second planar flight arranged adjacent one another,
wherein the front edge of the first planar flight and the rear edge of the second planar flight have complementary chevron shapes.

2. The molding apparatus of claim 1, wherein either of the right or left side edges of the first and second molding strips include an engaging structure comprising one of a slot or a fixation button.

3. The molding apparatus of claim 2, wherein the engaging structure is adapted to releasably engage a conveyor, the conveyor having the other of the slot or the fixation button.

4. The molding apparatus of claim 3, wherein the fixation button comprises a bolt, a movable pin, a screw or a tack.

5. The molding apparatus of claim 1, further comprising a freezing system adapted to apply a freezing solution on an outer surface of the pluralities of mold cups, wherein the freezing solution has a temperature capable of freezing the edible product within cavities of the mold cups.

6. The molding apparatus of claim 5, wherein the freezing system is positioned along a portion of a length of the conveyor.

7. The molding apparatus of claim 6, wherein the freezing solution comprises a calcium chloride solution or a propylene glycol solution.

8. The molding apparatus of claim 6, wherein the complementary chevron shapes are adapted to prevent the freezing solution from entering the cavities of the mold cups.

9. The molding apparatus of claim 8, further comprising a freezing solution collection area, positioned along a portion of the length of the conveyor downstream of the freezing system, wherein the freezing solution falling from the pluralities of mold cups is collected.

10. The molding apparatus of claim 1, wherein the first and second mold strips are substantially identical.

11. The molding apparatus of claim 1, further comprising three of more mold strips, all of which are substantially identical to one another.

12. A molding apparatus for forming a substantially frozen edible product, comprising a mold strip comprising a substantially planar flight having a front edge, a rear edge, and right and left side edges, and a plurality of mold cups fixedly secured along the planar flight, wherein the front and rear edges each comprise a lip, the lip having a chevron shape.

13. The molding apparatus of claim 12, wherein one of the right or left side edges includes an engaging structure comprising one of a slot or a fixation button.

14. The molding apparatus of claim 13, wherein the engaging structure is adapted to releasably engage a conveyor, the conveyor having the other of the slot or the fixation button.

15. The molding apparatus of claim 14, wherein the fixation button comprises a bolt, a movable pin, a screw or a tack.

16. The molding apparatus of claim 13, wherein the other of the right or left side edges includes one of at least one bore hole or at least one securement pin.
